(19) United States
(12) Patent Application Publication
(10) Pub. No.: US 2004/0137855 A1
(43) Pub. Date: Jul. 15, 2004

(54) Wireless mobile printing

(76) Inventors: Anthony John Wiley, Bristol (GB); Steven Andrew Battle, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/629,850

(22) Filed: Jul. 30, 2003

(30) Foreign Application Priority Data
Jul. 31, 2002 (GB) 0217832.5

(51) Int. Cl. H04B 1/40

(52) U.S. Cl. 455/88

(57) ABSTRACT

A printer on a network is selected to receive a file to be printed on the instigation of a mobile device. At least one user preference is wirelessly sent from the mobile device to a networked print controller. The print controller has access to the predetermined properties of a plurality of networked printers. At least one of the predetermined properties of the printers are then matched with the at least one user preference, which results in the selection of one or more printers which are suitable for printing the file. The predetermined properties of the networked printers can include the strength of signals between a wireless communications point on the network and the printers to identify the closest set of printers, and/or the size of paper the printer holds, the number of print jobs in the print queues, etc.

### BACKGROUND OF THE INVENTION

1. Field of the Invention

The present invention concerns improvements relating to mobile printing. It relates particularly, although not exclusively, to a method of printing from a mobile device, such as a laptop, to the nearest printer via a wireless connection. The present invention has application to mobile printing where a user is printing in an unfamiliar environment and does not know the location and/or other properties of the printers.

2. Description of the Related Art

Printing a file or document from a desktop computer to a fixed location networked computer is a well-established method. When a user wishes to print to such a printer, he selects the print option from a menu provided by the application he wishes to print from. He is then given a range of options, such as the printer he wishes to print to, the size of paper he wishes to use, the number of pages to be printed, and so on.

Although files printed by printers tend to be in a portable format (such as Postscript or Adobe's Portable Document Format), devices that initiate the printing of a file are required to actually drive the way in which the printer handles the file. This is carried out by a piece of software known as a printer driver. A printer driver is required for each printer that is connected to the network. The printer driver will usually be installed either on the user's desktop computer, or somewhere that is accessible to the user's computer, such as a file server.

With the advent of radical changes in the traditional office environment and business practices, the above-described method of printing documents is proving to be less than satisfactory to many users. One of the most dramatic changes to the traditional office environment has been the introduction of “hot desking”. Whereas in the conventional office, each worker has their own dedicated workspace (usually consisting of a desk, a desktop PC, and a place to store personal effects), “hot-deskers” are typically given no dedicated working area. Instead, they use any available space while they are in the office, and connect their laptops (rather than desktop PC's) to a computer network. This can be done using a docking station where a physical connection is made to the network or, alternatively, hot-deskers can connect their laptops to the computer network using wireless connections. Wireless connections are particularly useful in the hot-desking environment where employees cannot be enthralled at the prospect of crawling under their desk every morning in an attempt to plug their laptop into a docking station.

Another change to traditional business practices has arisen mainly because of the widespread use of laptop computers. It is now very common for a person visiting an organization to bring his laptop with him on which there is stored information for a presentation or a meeting—information such as documents, slide-shows, or even multimedia presentations. If a user wishes to print out a document in an unfamiliar environment, then two options are available to him. The first is to connect the laptop to a fixed location printer via a physical connection. One disadvantage of this method is that it requires a user to be aware of the printers in that particular environment. That is, the exact location of the printer, the name of the printer, and also the DNS (Domain Name System) name of the printer. In addition to this information, the user's laptop computer must have access to the correct printer drivers.

The second option, which obviates some of the above-mentioned problems, is to use mobile printing. That is, printing from the laptop to a printer using a wireless connection over which the file to be printed is sent. The wireless connection can conform to, for example, the IEEE 802.11 or Bluetooth protocols, or even an Infrared connection can be used. Conventional mobile printing using IEEE 802.11 or Bluetooth still has certain drawbacks, however, as the laptop has to either explicitly name the printer it wishes to print to or, if using an IR connection, then the mobile device needs to be in relatively close proximity to the printer. This last requirement can be a problem, as the majority of meeting rooms are not equipped to handle the printing of documents using IR links.

A further drawback of mobile printing in an unfamiliar environment is that a printer driver is still required for each printer that a user wishes to print to. This presents a problem for laptop users in such an environment in that they will almost certainly not know ahead of time what printers they intend to use, and hence which printer drivers to have installed.

One solution to this problem is provided by the Axis Communications Group using the Bluetooth communications protocol. They provide a networked print server that is able to print from a laptop to a remote printer. This is carried out using a dialog-based software program in the following manner. In order to print a document from a laptop, the laptop user selects the item he wants to print by selecting the item and choosing the “Print/Send” option. After the user has chosen print, he is shown a dialog window where he can select an installed printer. The laptop then scans the surroundings for Bluetooth enabled printers. When it has found the printer(s), it returns a new message window to the user listing all available printers. The user then selects the printer and prints to it directly.

In most situations, a user will want to print to their nearest printer. The disadvantage of the above-described method is that a user who wishes to print from their laptop in an unfamiliar environment can have no idea where his nearest printer is, as meeting rooms are not usually equipped with printing facilities. This means that the user will not know which of the list of printers that is shown to him is the nearest, or which printer is a color printer, which printer contains A3 paper, or which has the facility to print slides, etc.

An aim of the invention is therefore to provide a method of identifying a suitable printer to print to from a mobile device over a wireless communications link, the most suitable printer being the nearest printer, and/or having properties that meet the user's requirements.

One method that has been utilized in mobile printing for locating the position of the mobile device is the triangulation method. This method is used to locate mobile devices relative to a set of wireless access points or transceivers, but this involves relatively complex algorithms by measuring the strength of the wireless signals (and its possible direction) from a source. Basing a location measurement on signal strength alone requires at least two distinct measurement points to be taken for a relative direction and/or distance calculation to be made. This makes triangulation a complex solution.

Another aim of the invention is therefore to provide a simple and quick method of identifying the nearest printer to the mobile user. A further aim of the invention is to provide a centralized facility that enables users who are new to an office, company or other environment to print wirelessly from mobile devices.

### SUMMARY OF THE INVENTION

According to a first aspect of the invention, there is provided a method of selecting a printer on a network to receive a file to be printed on the instigation of a mobile device, the method comprising: sending at least one user preference from the mobile device to a networked print controller, the print controller having access to the predetermined properties of a plurality of networked printers; matching at least one of the predetermined properties of the printers with the at least one user preference; and selecting the printer which is to print the file from the results of the matching step.

This method has particular advantages when the user is new to an environment and he has no knowledge about the printers that are available in that environment. The print controller (print service) automatically selects the “best” printer for the user to print to, if necessary without any input being required from the user.

Preferably the printers are part of a computer network such as a wired local area network (LAN). Preferably the network also includes one or more wireless communication points (also known as wireless hubs) that send and receive signals to and from the mobile device thereby enabling the mobile device to access the network.

Preferably the user preference comprises the current location of the mobile device, and the method further comprises: determining the location of the mobile device relative to at least one wireless communication point of the network by measuring a transmitted wireless signal strength of the at least one wireless communication point at the current location of the mobile device; wherein the sending step comprises transmitting the measured signal strength to the print controller via the network; the matching step comprises comparing the measured wireless signal strength at the mobile device with a plurality of stored wireless signal strengths of the at least one communications point at each of the printer locations; and the selecting step comprises selecting a printer to send the file to, having the best match resulting from the comparing step.

The wireless communication points can be standalone devices, or they can connect via cabling to the network. The wireless communication points can be server computers, in which case the print service can be installed on one or more wireless hubs. If this is the case, then the file to be printed can be sent directly to the print service.

The transmission of signals over the network can be carried out by Ethernet (IEEE 802.11), Bluetooth, or any other suitable transmission protocol.

The file to be printed can reside on the user's mobile client device, or at another location, such as a file server. The method in accordance with an embodiment of the present invention can thus include the further step of making a connection to the file server via the wireless hub in order to access the file.

Properties of the printer(s) stored at the print service facility preferably include information regarding the strength of the radio signals between the wireless hubs and the printers (referred to hereinafter as the hub signal strengths). The maximum value of hub signal strength is 1.0 which indicates maximum signal strength, and the minimum value of the hub signal strength is 0.0, indicating that there is no detectable signal between the wireless hub and the printer. Any intermediate values indicate a varying hub signal strength.

If this hub signal strength information is available from the print service, then the method in accordance with an embodiment of the present invention can be used to select the nearest printer to the user by making the assumption that the stronger the signal between a printer and a wireless hub, the closer the hub is to that printer. For the case where there are many printers in the network, the method of the invention can be used to select the closest printers to the mobile device. This option is most preferably the default option, in which case the user does not have to explicitly request printing to the nearest printer or the closest printers. However, if the user does not wish to print to the nearest printer (or closest printers), but wishes to print to, for example, a printer next to a coffee machine, then the print service can provide the user with the option of changing this default option to his preferred option. The advantage of this is that the user can select the location of the printer that he prints to, rather than the actual printer that is to be printed to. The method in accordance with an embodiment of the present invention therefore advantageously includes the further step of providing the user with the option to select one or more is to be used in the matching process.

Other properties that can be stored at the print service include information about the printers, such as the size of paper the printer holds, the number of print jobs in the print queue for a particular printer, and/or the total size of the print jobs. The printer properties preferably further include the location of the printer drivers, or the printer drivers themselves, and the make and model of the printer. Some of this information can be held at a remote location, in which case the print service can include instructions on how this information can be obtained. For example, the printer driver for a particular printer can be held on a print server, in which case the print service can contain the DNS name of the print server. The advantage of providing printer driver information at the print service is that a user who is new to the environment in which an embodiment of the present invention is being implemented does not have to know in advance which printers he can print to, and he therefore does not require any printer drivers to be installed on his mobile device.

Information about the printers can also be accessible directly from the printer manufacturers. In this case, the print service can contain instructions on how to obtain this information. When the user requests the printing of a file, if the information about the printers is not available on the print service, the method in accordance with an embodiment of the present invention can include the further step of obtaining this information on-line, preferably from the printer manufacturer's Web site. The advantage of this is that information held at the print service can be easily and quickly updated to ensure that the print service is kept up-to-date. This is particularly important if new versions of software are being regularly installed and the printer drivers need to be updated on a regular basis so that printing from the new software is enabled.

Alternatively, the printer properties can be stored at a central location. This provides the advantage of facilitating the updating and management of the print service facilities.

The matching step is preferably implemented by way of a matching program. In the first instance, the matching program advantageously compiles a list of the printers that meet with the user's preferences. For example, if a user wishes to print to A3 paper, and the printer p1 does not have this facility, then this printer will not be available for subsequent matching program steps. Or, for example, if the user would like to print to a color printer, and printer p2 does not have this facility, this printer will also not be available for the subsequent matching program steps.

Once this list has been compiled, a further step of the matching program is preferably to determine the nearest printer (or the set of closest printers) to the user using the printers that appear in this list. This is preferably achieved by comparing the hub signal strength(s) of the printers with the hub signal strength(s) of the mobile client device. The method in accordance with an embodiment of the present invention therefore includes the further step of measuring the strength(s) of the signal(s) between the wireless hubs and the mobile client device. Preferably, multiple hub signal strengths are registered for each printer. This ensures that there is a higher chance of a printer being visible to a mobile device if there are many more hubs than printers.

Preferably the nearest printer to the mobile client device is found by identifying the wireless hub h that has the strongest signal between it and the mobile client device.

The printer which has the same wireless hub h as its nearest hub (i.e., with the highest hub signal strength) is then preferably selected as the nearest printer to the mobile device. If there are two or more printers with identical hub signal strengths for hub h, then preferably the hub with the second largest signal is matched for both the mobile client device and the printers. Alternatively, another property of the printer can be selected to be matched with the user's preferences in order to find the nearest most suitable printer. Again, the user can explicitly select the property, or it can be selected for the user by the print service. So, if two printers are identified as being the nearest printers, the print service can select the least busy printer as being the nearest printer. The print service can, however, randomly choose between two or more printers that have been identified as the nearest printers.

Where there are two or more wireless hubs, the set of closest printers to the mobile client device is preferably found by determining the printers that have the largest number of detectable hubs in common with the mobile client device. If more than one printer is identified, then the method in accordance with an embodiment of the present invention can further include the step of displaying to the user the set of closest printers, so that he or she can decide which printer to print to. The user can also be provided with the location of the printers and/or the performance criteria of each printer in this set to aid the selection of the “best” printer.

For both matching methods, the name given to the printer(s) can indicate to a user where the printer is located, e.g. “Printer X at Piller 5”, and this name can be displayed to the user. Alternatively, or in addition to this information, the position of the printer(s) can be indicated to the user by way of a plan or even audio instructions giving directions to the printer(s).

The method in accordance with the present invention can include the further step of providing to the user a method of ranking printer properties in order of importance. For example, the user's most important requirement can be to print to the least busy printer rather than the nearest printer. This gives the user more control over the printing procedure.

An advantage of the matching program for identifying the nearest printer, or set of closest printers, to the mobile client device, is that it is very simple and quick to use. It does not require accurate determination of the positions of the printers in real time, nor does it involve complex calculations, or any additional dedicated hardware to run the algorithm.

The algorithm can be implemented in any office environment that has a wireless network simply by recording the hub signal strengths of the printers and the mobile client device. Prior art complex algorithms that have long execution times are not suitable for real-time printing, especially as a good wireless hub can support up to 60 simultaneous users. The matching program in accordance with an embodiment of the present invention also has the advantage of not becoming more complex as the number of wireless hubs increases, thus enabling an organization to expand their network without concern.

The method in accordance with an embodiment of the present invention can also include the step of establishing a secure connection between the mobile device and the print service. This can require the user to provide authentication of his identity in order to access the network and thus the print service by way of, for example, a password.

The method in accordance with an embodiment of the present invention preferably also includes the step of registering printer properties with the print service. This can be done manually by, for example, a print service administrator. Alternatively, at least one of the printer properties can be automatically registered with the print service directly from the manufacturer or from a remote facility.

A further advantage of this invention is that it is platform and network independent, which means that it can be installed on any suitable network just by implementing the print service.

According to another aspect of the present invention there is provided an apparatus for selecting a printer on a network to receive a file to be printed on the instigation of a mobile device, the network having at least one communications point for providing access to devices on the network from the mobile device, the apparatus comprising: a print controller connected to the network and having access to predetermined properties of a plurality of networked printers; the print controller being arranged to receive at least one user preference from the mobile device via the communications point; and a matching program arranged to match at least one of the predetermined properties of the printers with the at least one user preference, and to use the results of the matching to select the printer which is to print the file.

Some or all of the printer properties can be embedded in an XML document so that a Web browser can read them. This is particularly useful where a printer property is being supplied online by a printer manufacturer in which case it is very easy to integrate the information supplied by the printer manufacturer with the information held at the print service.

The print service can also include an automatic update means to automatically install the latest versions of printer drivers at the print service, or to install other information about the printers.

A presently preferred embodiment of the present invention will now be described by way of example with reference to the accompanying drawings.

### BRIEF DESCRIPTION OF THE DRAWINGS

FIG. 1 is a schematic diagram of part of a network system suitable for implementing one embodiment in accordance with the present invention;

FIG. 2 is a schematic diagram of elements of a print service of the network system of FIG. 1;

FIG. 3 is a flow diagram of the process of printing a document to the most appropriate printer using the network system of FIG. 1;

FIGS. 4a to 4d are the dialog menus that are presented to a user during performance of the method of FIG. 3;

FIGS. 5a and 5b are diagrammatical representations of mobile print application menus for registering a printer with the print service, according to the presently preferred embodiment of the present invention;

FIG. 6 is a schematic diagram of the positions of two wireless hubs in an explanatory example;

FIG. 7 is a schematic diagram of the positions of two wireless hubs, two printers, and two mobile device sensing positions in another explanatory example; and

FIG. 8 is a schematic diagram of the positions of three wireless hubs, two printers, and two mobile device-sensing positions in a further explanatory example.

### DETAILED DESCRIPTION

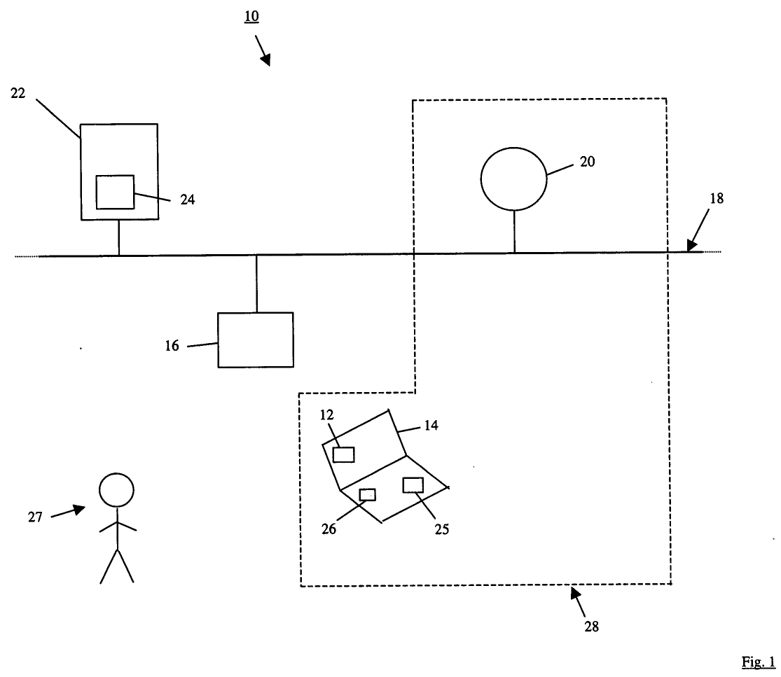

FIG. 1 is a schematic diagram of part of a system 10 suitable for implementing one embodiment in accordance with the present invention which enables printing of a document 12 from a mobile device 14, such as a laptop, to a network printer 16 that best matches a user's requirements.

The part of the system 10 of FIG. 1 comprises a wired network 18 and a mobile device 14. The wired network 18 comprises an access point or wireless hub 20, a print server 22 and a printer 16. However, in the performance of the present embodiment, the system comprises additional wireless hubs 20, and also a plurality of printers 16 that are not shown in FIG. 1.

The mobile device 14 is equipped with a piece of hardware, such as a mobile networking card 25, so that the device 14 can be wirelessly coupled to the access point 20 and can thereby communicate with the other components 16, 20, and 22 of the wired network 18. A mobile print application 26 is installed on the mobile device 14 to control communications with the print server 22 via the networking card 25 and the wireless hub 20. The mobile device 14 and the wireless hub 20 form part of a wireless network 28 whose components communicate with each other via radio frequency signals. Although the print server 22 and the wireless hub 20 are shown as two separate components of the network, the skilled person will recognize that they can be combined into one single unit. That is, the wireless hub 20 can also act as a server.

The print server 22 is arranged to host a print service 24 that enables a user 27 to print to the “best” or most appropriate printer from their mobile device, which in this embodiment is a laptop computer 14.

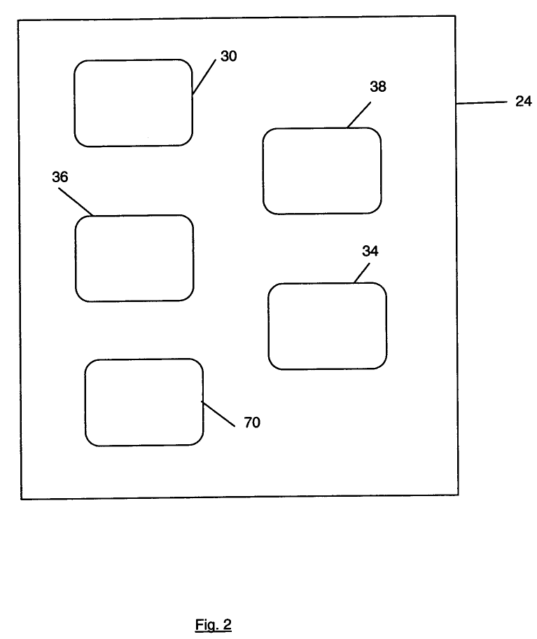

The print service 24 of FIG. 2 includes a plurality of printer drivers 30 for each of the networked printers 16. As the network contains more than one type of printer 16, the print service 24 contains details of printer drivers for each make and model of the printers that are part of the network 18. Also included at the print service is a mobile print monitoring application 70. This monitors the mobile print applications 26 installed on mobile devices 14 that are in the vicinity of (and therefore detectable by) the network.

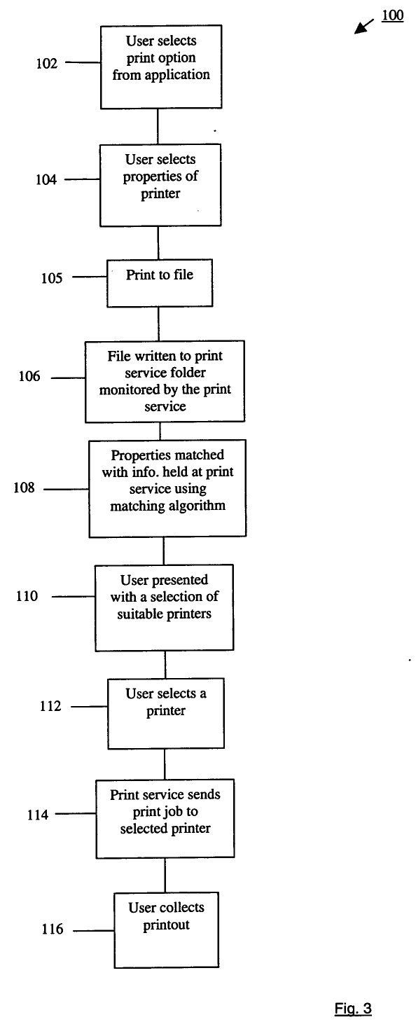

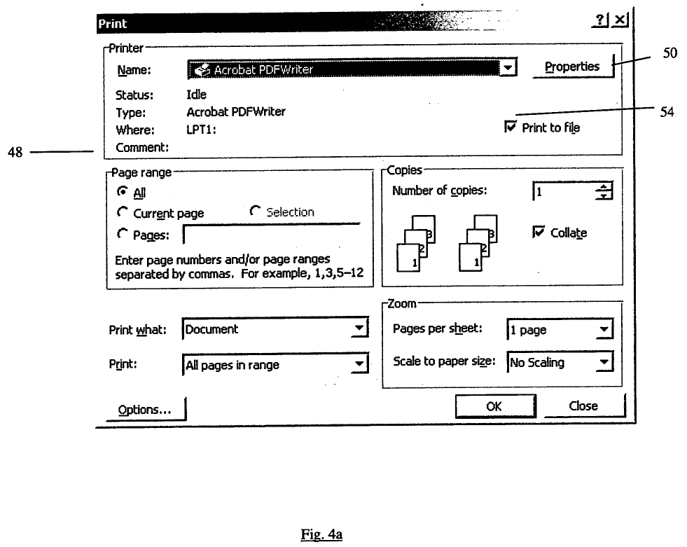

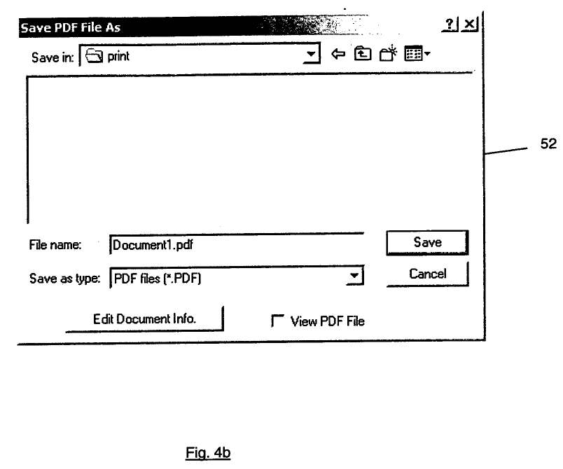

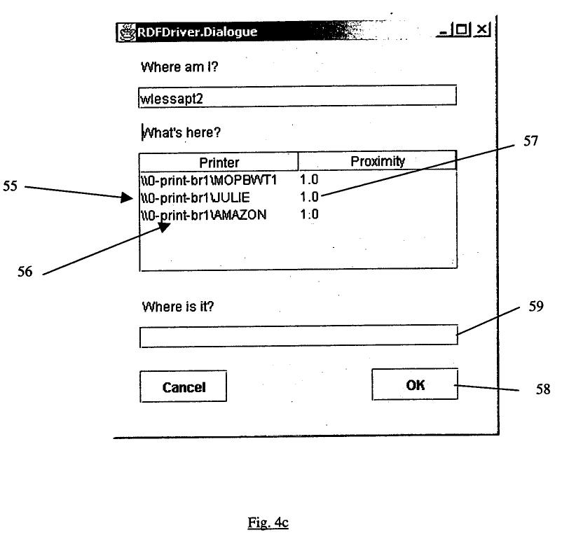

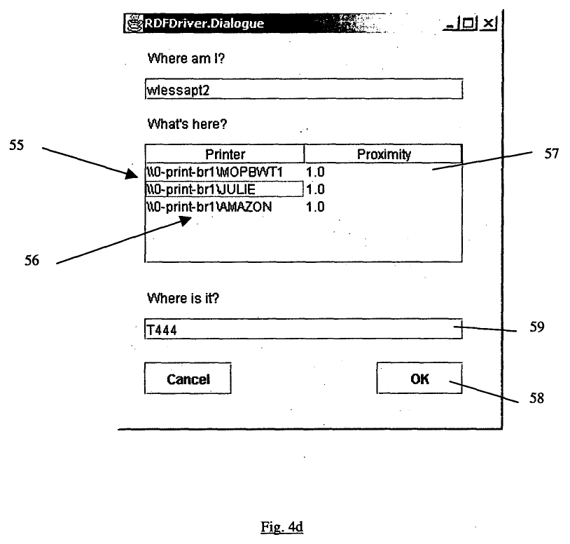

The print service 24 also contains information about each printer (known as “printer properties”) e.g., paper type (headed or plain), paper size (A4 or A3). The print service 24 further contains the strength of wireless signals measured at each of the printer locations, of wireless hubs 20 (i.e., the hub signal strengths 36), together with a matching program 38 that calculates either the nearest printer or the set of closest printers to the user 27 and also matches the user's preferences to the printer properties. The way in which the matching program 38 functions will be discussed in detail later on. Firstly, the method steps in accordance with one embodiment of the present invention in which the print service 24 is used to provide a user 27 with a set of closest printers to print to are explained with reference to FIGS. 3, 4a, 4b and 4c.

With reference to FIG. 3, the method 100 commences with the user 27 selecting at 102 the print option from the application they would like to print from (it is assumed here that the user 27 wishes to print a document 12 that resides either on his laptop 14, or somewhere on the network 18). From FIG. 4a, it can be seen that the print service 24 can be make to look like any other printer that is “installed” on a computer. The user 27 can, for example, select the page numbers to be printed, the number of copies to be printed, and to scale the document to fit the paper size, etc.

Upon selecting the print option from the application menu, the user 27 is given the opportunity to select at 104 various properties of the printer from a print application dialog window 48 (as shown in FIG. 4a) by clicking on the “Properties” button 50 displayed. This displays a properties dialog window (not shown) that presents to the user 27 certain properties of a printer that can be selected by the user. For example, the user 27 can wish to print a color document on A4 paper. He would then select the “Color” option and the “A4” paper option in the properties dialog window.

In the next step, the user 27 chooses at 105 the “print to file” option by checking the “print to file” box 54 displayed in the print application dialog window 48. This step causes the dialog window 52 as shown in FIG. 4b to be presented to the user 27, thereby enabling the user to select a file name (e.g., “Document1.pdf”) to print the document 12 to. The user then selects at 106 the print service “print” folder (specified by the path name shown in the “Save in:” field of dialog box 52) that causes the document 12 to be written to this folder. The appearance of the document 12 in this folder triggers the mobile print application 26 that initiates determination of the current relative location of the user 27 and querying of the print service 24 to determine which printers have been registered within the vicinity of the user. The mobile print application 26 then sends a print request wirelessly from the laptop 14 to the print service 24.

When the print service 24 registers the request to print the document (i.e., when it is noticed that the file (document) 12 has been written to its print folder), the measurement of the strength of the wireless signal between the user's laptop 14 and the wireless hub 20, namely the measurement of the hub strengths at the mobile device's location, is triggered. The wireless hub 20 that is used to convey the print request to the print service 24 is not absolutely critical, although it is preferable to use the hub with the strongest signal strength to communicate information to the print service as this generally provides the fastest transfer of data. In practice, there will be more than one wireless hub signal detectable by the user's laptop 14, and therefore there will almost certainly be a set of “hub, signal strength” pairs—one pair being recorded for each hub 20 where there is a signal strength of greater than zero.

In the next step, the matching program 38 matches at 108 the desired printer properties which have been selected by the user 27 with the printer properties for all the printers 16 that are registered at the print service 24. For example, suppose there are five printers p1, p2, p3, p4 and p5 registered with the print service 24. Printers p1, p3 and p4 are color printers, and only printer p4 can print on A3 paper. If the user 27 selects that he wishes to print a color document on A3 paper, then the matching program 38 will select printer p4 as the most appropriate printer as this is the only printer that meets all of the user's requirements. On the other hand, if the user 27 wishes to print a black and white document on A4 paper, then all five printers will be suitable for this job. The matching program 38 will use all five printers in order to identify the closest printer(s) to the user 27 (or rather to the user's laptop 14). The method by which the set of closest printer is identified is described in detail later.

After the matching program 38 has identified the closest printer or set of closest printers, the user 27 is presented at 110 with the details of the printer(s) that meets his requirements. An example of this is shown in FIG. 4c. In addition to the names of the suitable printers set out in a list 55, the user 27 is also provided with brief details 56 of the location of the printer(s) and its proximity 57 to the user. As several printers are presented to the user 27 which meet his requirements (all being of equivalent proximity to the laptop 14), the user selects at 112 a printer from the list 55 and clicks on the “ok” button 58. The print service 24 then sends at 114 the print job to the selected printer 16, and the user 27 proceeds at 116 to the printer to collect the printout. If the user is not sure where the printer 16 is located in the office, clicking on the printer name displays the detailed location 59 of the printer, as shown in FIG. 4d.

In order for the present embodiment to be implemented, the print service 24 first has to be set up (or initialized) so that the correct information about the printers 16 is available for use in the way that has been described above. The set-up procedure includes registering the properties of the printers that the print service 24 is servicing, registering the strength of wireless signals between printers 16 and wireless hubs 20, and installing printer drivers 30 for each printer 16.

Assuming that the printers 16 are directly connected to the fixed (wired) network 18, ascertaining the strength of the wireless connection between a printer 16 and the wireless hub 20 is achieved by placing a mobile device 14, such as a laptop, next to (or on top of) the printer 16, and using the program (not shown) associated with the wireless networking card in the laptop to measure the strength of signal from each wireless hub 20 (hub strength) at the printer. This procedure (known as the registration procedure) can be undertaken by, for example, a print service administrator.

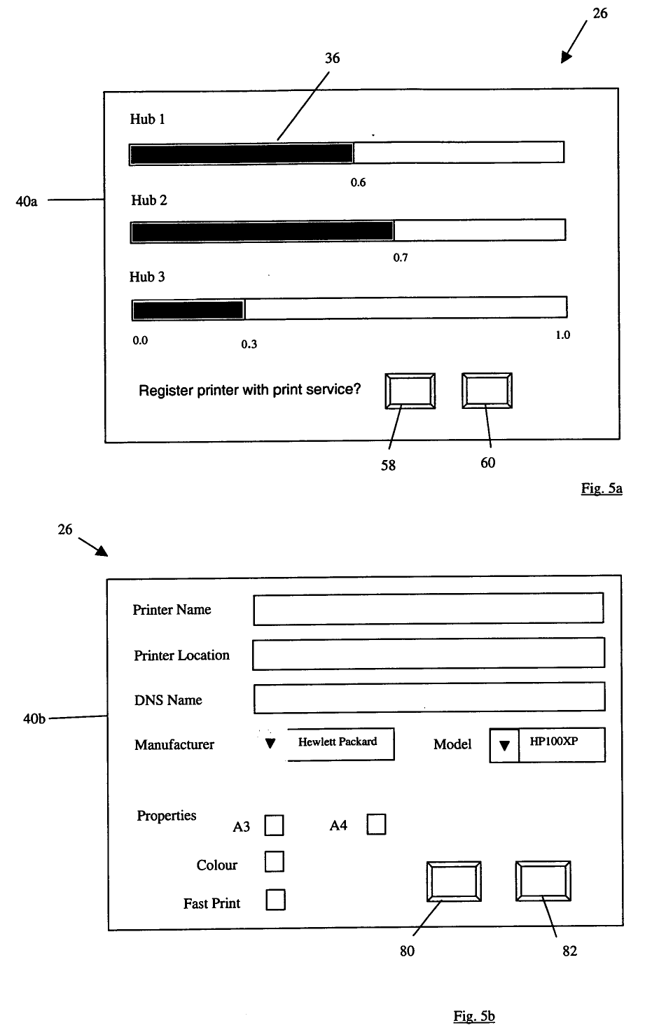

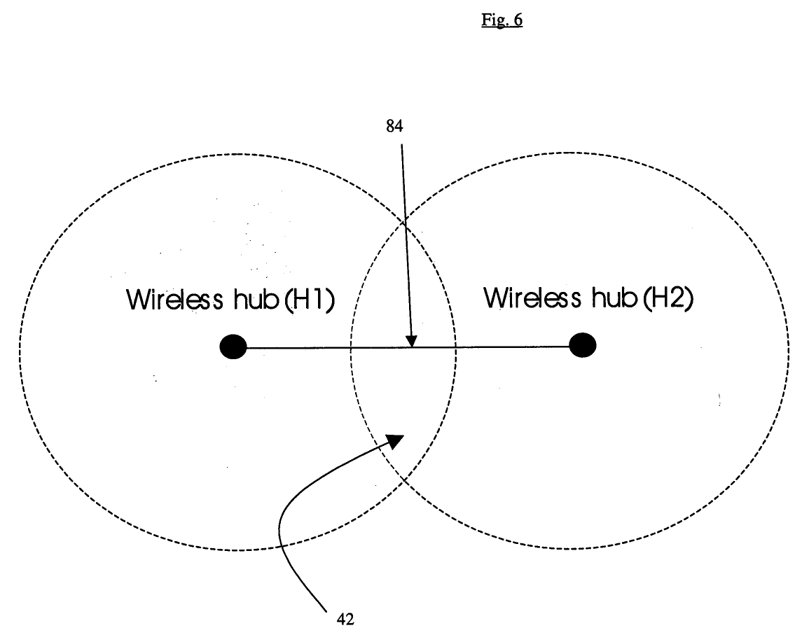

Registration can be undertaken manually, e.g., by recording the hub strengths and then updating this information to the print service 24 at a later date, or “automatically” using the mobile print application 26 in situ. The mobile print application 26 is menu based, as shown in FIGS. 5a and 5b. When the print service administrator places his mobile device 14 near to the printer 16 that is to be registered with the print service 24, he initializes the mobile print application 26. As can be seen from FIG. 5a, the mobile print application menu 40a displays the hub signal strength 36 for each hub that can be detected by the printer 16. In this example, three hubs H1, H2 and H3 can be seen.

The print service administrator then has the option of registering the printer with the print service 24 (by clicking the “yes” button 58), or saving the hub strength signals (by clicking the “save” button 60), in which case another dialog window 40b is displayed as shown FIG. 5b. Using this dialog window 40b, the print service administrator can enter the name of the printer 16, the location of the printer (e.g., next to the coffee machine on the fifth floor), the DNS name, the make and model of the printer, and other printer properties. Again, this information can be uploaded directly to the print service 24 (by clicking on the “send” button 80) or saved for uploading at a later date (by clicking on the “save” button 82).

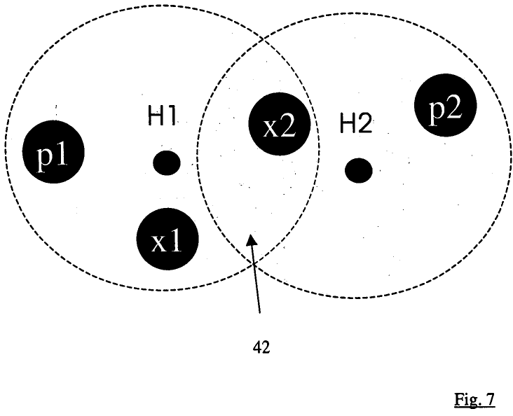

In an ideal world, for each wireless hub 20 there would be a corresponding printer 16 nearby which would be able to satisfy all the possible printing requests of a mobile user 27. However, in a real office environment, more than one hub is likely to be visible to a printer, and there will be many printers. Such a scenario is now discussed firstly with reference to FIG. 6.

Consider a network wired 18 having only a single wireless hub H1. As the user 27 moves away from the hub H1 in any straight-line direction, then the hub signal strength 36 decreases inversely proportionally to the square of the distance from the hub. So the signal strength from a hub quite rapidly deteriorates as the user 27 moves away from it. Below a certain threshold (that is at a certain distance), the hub H1 will become unusable, as the signal strength is too weak to be able to transmit information.

Now, if a second hub H2 is introduced in order to provide adequate coverage for the users in the environment (i.e., there are no areas in which a laptop 14 is out of range of either hub), the hubs need to be physically located in the environment in such a way that at some points they will both be visible to the user's mobile device 14. This area of overlap 42 is shown in FIG. 6.

Now consider the user 27 walking from wireless hub H1 to hub H2 along line 84. At hub H1, the only signal the user's mobile device 14 detects is that of hub H1. As the user 27 walks towards hub H2, the signal from H1 will decrease and, at some point, the signal from hub H2 will reach a threshold where it also becomes visible to the user's laptop 14. If hubs H1 and H2 are close enough to one another, then the user 27 will enter the area of the overlap 42 and be able to detect the signals from both hub H1 and hub H2. As the user 27 carries on walking towards hub H2, at some point the signal from H1 signal becomes so weak that it becomes “invisible”, and the user's laptop 14 can only detect the signal from hub H2. Clearly, the more densely packed the hubs are, the more hub signals are likely to be seen at any particular point in the region covered by the hubs, which gives better connectivity to the network 18.

When it comes to ascertaining and registering the locations of devices (be it printers or mobile devices) in an environment that is adequately covered by a set of hubs, it is generally expected that more than one hub 20 will be visible from the location of most of these devices. This information can be used to improve the way in which the relative proximity of the mobile device and the printer is derived, as the more data the matching program has access to, the more comparisons between the hub signal strength measurements can be made.

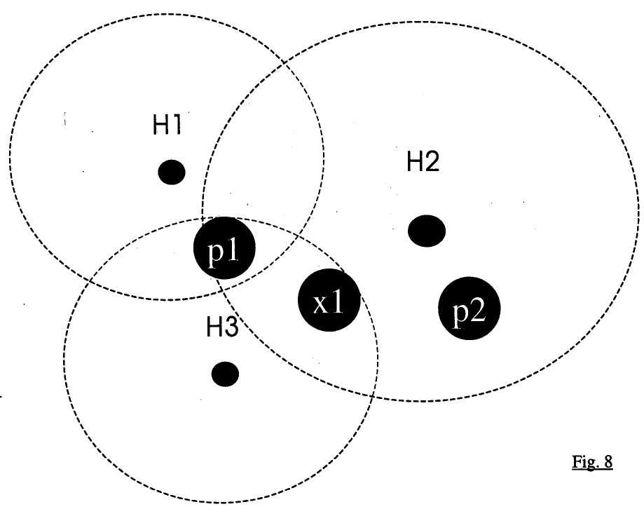

A simple means of finding the nearest printer to the user 27 is to look at the strongest hub signal detected by the user's laptop 14, and to match this hub signal against the set of printers that have this same hub as their strongest signal. This is illustrated with reference to FIG. 7, in which there are shown two hubs (H1 and H2) and two printers (p1 and p2). In this example, the hub signal strength 36 of printer p1 from H1 is 0.9, and the hub signal strength of printer p2 from H2 is 0.5. The signal from hub H1 is not visible to printer p2, and the signal from hub H2 is not visible to printer p1.

Now considering the position of the user 27 with respect to the hubs, the strength of the signal from H1 to the user 27 at position x1 is 0.8, and the strength of the signal from hub H2 is 0.0. The mobile device's strongest hub signal, and therefore the nearest hub, is H1. The printer with H1 as its strongest hub signal is printer p1 (with a hub signal strength 36 of 0.9). The matching program 38 will choose printer p1 as the nearest printer.

Now consider the user 27 moving to position x2, which is located in the area of overlap 42 between hubs H1 and H2. The strength of the signal from hub H1 to the user at this position is 0.2, and the signal strength from hub H2 to the user's position is 0.6. The nearest printer to the user 27 at this position is therefore printer p2 as it is the strongest hub signal for both the user and the printer p2.

In the above example, if the user's laptop 14 at position x1 has the hub strengths {[H1,0.6],[H2,0.3]}, then H1 was the closest hub. However, if there is more than one printer 16 with the same hub signal strength 36, then the second strongest hub strengths of these printers are compared with those of the mobile device, and so on.

In this next example, the hub signal strengths 36 for printers p1 and p2 are {[H1,0.8],[H2,0.3]}for printer p1, and {[H1,0.8],[H2,0.4]} for printer p2. As both printers p1 and p2 have the same hub signal strength 36 for wireless hub H1, the hub signal strengths of the second hub are compared. In this case printer p1 is considered to be the closest, as its hub signal strength 36 with respect to hub H2 is similar to the hub strength of x1 measured relative to H2. If the strongest hub signal for the mobile device matches the strongest hub signal for two printers, and there are no more hubs to be matched, then either printer can be chosen at random as being the nearest printer.

For the situation in which there are many wireless hubs 20 in an environment (as is likely to be the case in a real office environment), the matching program 38 can be used in order to identify a set of closest printers to the user 27, rather than the nearest printer. The use of the algorithm 38 in this respect is now described with reference to FIG. 8.

The more wireless hubs 20 there are in an office, the more (hub, signal) pairs will be registered with the print service 24 for each printer. Depending on the number of hubs that are “visible” to the printers, each printer will in all likelihood have a different number of (hub, signal) pairs associated with it. FIG. 8 shows a schematic view of an environment where there are three hubs (H1, H2 and H3) and two printers (p1 and p2). The hub signal strengths 36 for printer p1 are {[H1, 0.6], [H3,0.2], [H2, 0.1]}, indicating that printer p1 detects the signals from three hubs.

The hub signal strengths 36 for printer p2 are {[H2, 0.5]} which indicates that printer p2 can only detect the signal from a single hub.

As described previously, during performance of the method in accordance with an embodiment of the present invention, a laptop 14 reports its location to the print service 24 by providing a set of (hub, signal) pair readings. According to this example, the set of hub signal strengths 36 is given as {[H3, 0.3], [H2,0.2]} for the laptop 14 located at position x1. The second algorithm 38 finds the set of closest printers by ascertaining the maximum intersection of the laptop's (hub, signal) pairs with those of the registered printers' (hub, signal) pairs. A simple way to do this is to identify the printers which have the largest number of visible hubs in common with the mobile device.

In FIG. 8 for example, a laptop 14 positioned at x1 detects the signals from hubs H2 and H3, but not H1. Printer p1 also detects signals from hubs H2 and H3, whereas the only hub that the user's position at x1 has in common with p2 is hub H2. Hence printer p1 is chosen as the closest printer because it has a higher number of common hubs (or the largest intersection). If the printer p2 is moved so that it too detects signals from H2 and H3, then both printers p1 and p2 are presented to the user 27 as being “appropriate” printers. This scenario is shown in FIG. 4c, where the user has been presented with a choice of three suitable printers. The user must then select which printer he wants to print to.

From the example of FIG. 8, it can appear that printer p2 is closer to the user's position x1 than printer p1. Indeed, this can in fact be true, in which case it would seem that printer p2 should be presented to the user 27 as the most suitable printer, rather than printer p1. However, in a region that contains a large number of densely packed hubs and printers, this does not matter. Absolute accuracy of the matching program 38 is not the aim of the present invention: an estimation of the closest printer using a very simple and quick algorithm is the desired result. Using the second algorithm to identify the closest printer(s) to the user 27 can result in the user having to walk an extra meter or so to pick up their print job, but this disadvantage is clearly outweighed by the other additional benefits that the present invention provides.

As printers registered with the print service 24 can be possibly moved from the locations that are registered with the print service, ongoing monitoring of the location of the printers is a necessity. If a printer has been moved from its registered location to a new location, then its new location and associated hub signal strengths 36 must be communicated to the print service 24 to enable re-registration of the printer. As in the registration procedure, re-registration of the printer's new location (that is, the new hub signal strengths) can be achieved either automatically, or manually.

It is to be appreciated that several further variations of the present embodiment have been discussed in the introduction and these are not reported here for the sake of brevity. The performances of these variations will be clear to those skilled in the art.

Having described a particular embodiment in accordance with the present invention, it is to be appreciated that the embodiment in question is exemplary only, and that variations and modifications such as will occur to those possess of the appropriate knowledge and skill can be made without departure from the spirit and scope of the present invention as set forth in the appended claims. For example, the present invention can also be suitable for use with mobile devices other than laptops, such as mobile (cellular) phones, personal digital assistants (PDAs) and digital cameras. Indeed, any device that can be wirelessly connected to a network would be suitable.

Additionally, printer registration and/or re-registration can be carried out by “piggy-backing” off the “walk-up and print” method. If a mobile print application installed on the mobile device is able to monitor the activity of the mobile device, it will be able to detect if the mobile device is using an IR (Infrared) link to print to a printer by listening to all print requests. If an IR link is being used (which implies that the print service is being bypassed as the print signal is not being directed via a wireless hub), the mobile print application contacts the print service and enquires whether the printer being printed to is registered with the print service. If it is not, then the mobile print application sends the registration information to the print service. This method, of course, assumes that the mobile device is also equipped with a non-IR interface by which hub signal strengths can be measured, and that during “point and shoot” printing, the mobile device is in close proximity to the printer. If the printer is already registered with the print service, then the registration information could still be sent to the print service to ensure that the information for that particular printer is correct.

What is claimed is:

1. A method of selecting a printer on a network to receive a file to be printed on the instigation of a mobile device, the method comprising:
sending at least one user preference from the mobile device to a networked print controller, the print controller having access to predetermined properties of a plurality of networked printers,
matching at least one of the predetermined properties of the plurality of networked printers with the at least one user preference, and
selecting the printer that is to print the file in accordance with the results of matching at least one of the predetermined properties of the plurality of networked printers with the at least one user preference.

2. The method of claim 1, wherein the user preference comprises a current location of the mobile device and the method further comprises:
determining a location of the mobile device relative to at least one wireless communication point of the network by measuring a transmitted wireless signal strength of the at least one wireless communication point at the current location of the mobile device;
wherein sending at least one user preference from the mobile device to a networked print controller comprises transmitting the measured signal strength to the print controller via the network;
wherein matching at least one of the predetermined properties of the plurality of networked printers with the at least one user preference comprises comparing the measured wireless signal strength at the mobile device with a plurality of stored wireless signal strengths of the at least one communications point at each of the printer locations; and
wherein selecting the printer that is to print the file comprises selecting a printer to send the file to having the best match resulting from comparing the measured wireless signal strength at the mobile device with a plurality of stored wireless signal strengths of the at least one communications point at each of the printer locations.

3. The method according to claim 1, further comprising selecting at least one print requirement for the file, and communicating the print requirement to the print controller, wherein matching at least one of the predetermined properties of the plurality of networked printers with the at least one user preference comprises comparing the at least one print requirement with the predetermined abilities of each of the networked printers and the selecting step comprises excluding all printers that do not have the desired at least one print requirement.

4. The method according to claim 2, further comprising selecting at least one print requirement for the file, and communicating the print requirement to the print controller, wherein matching at least one of the predetermined properties of the plurality of networked printers with the at least one user preference comprises comparing the at least one print requirement with the predetermined abilities of each of the networked printers and the selecting step comprises excluding all printers that do not have the desired at least one print requirement.

5. The method according to claim 1, wherein the predetermined abilities of the printers are stored in the print controller and the method further comprises retrieving the stored predetermined abilities.

6. The method according to claim 1, wherein the predetermined abilities of the printers are stored remotely from the print controller and the method further comprises retrieving the stored predetermined abilities from the remote store.

7. The method according to claim 2, wherein the predetermined abilities of the printers are stored remotely from the print controller and the method further comprises retrieving the stored predetermined abilities from the remote store.

8. The method according to claim 3, wherein the predetermined abilities of the printers are stored remotely from the print controller and the method further comprises retrieving the stored predetermined abilities from the remote store.

9. The method according to claim 1, wherein matching at least one of the predetermined properties of the plurality of networked printers with the at least one user preference comprises comparing at least one of the current number and size and print jobs in each of the printers' memories and selecting the printer that is to print the file comprises selecting the printer with the lowest number and/or size of print jobs.

10. The method according to claim 2, wherein selecting the printer that is to print the file comprises selecting the printer having its strongest signal strength from the same wireless communication point as that of the strongest signal strength of the mobile device.

11. The method according to claim 2, wherein the network comprises a plurality of wireless communication points and the strongest signal strengths of the printer and the mobile device are equal, and selecting the printer that is to print the file further comprising selecting the printer having its second strongest signal strength from the same wireless communication point as that of the second strongest signal strength of the mobile device.

12. In the method according to a claim 2, wherein the network comprises a plurality of wireless communication points and selecting the printer that is to print the file comprises selecting the printer having the largest number of non-zero signal strengths of the wireless communication points in common with the measured signal strengths at the mobile device.

13. The method according to a claim 2, further comprising displaying to the user a list of details of a plurality of best-matched printers suitable for unique selection and selecting the printer that is to print the file further comprising the user manually selecting one of the printers on the list.

14. The method according to claim 13, wherein displaying to the user a list of details of a plurality of best-matched printers suitable for unique selection comprises displaying the actual location of each of the plurality of best-matched printers.

15. The method according to claim 2, further comprising sending to the mobile device a map of directions to the selected printer, a set of audio or written directions to the selected printer or a selected printer location name.

16. A method of printing a file to a networked printer at the instigation of a mobile device, the method comprising:
selecting a networked printer comprising:
sending at least one user preference from the mobile device to a networked print controller, the print controller having access to predetermined properties of a plurality of networked printers,
matching at least one of the predetermined properties of the plurality of networked printers with the at least one user preference, and
selecting the printer that is to print the file in accordance with the results of matching at least one of the predetermined properties of the plurality of networked printers with the at least one user preference; and
transmitting the file to the selected printer for printing.

17. The method according to claim 16, wherein the file is stored on the mobile device, is transmitted to the print controller via a wireless communication point and subsequently forwarded onto the selected printer for print out.

18. The method according to claim 16, wherein the file is stored on a networked file server, is selected by the mobile device and subsequently sent to the selected printer for print out by the print controller.

19. The method according to claim 16, further comprising accessing the relevant printer driver for the selected printer from a plurality of printer drivers stored at the print controller or a networked location accessible by the print controller.

20. The method according to claim 17, further comprising accessing the relevant printer driver for the selected printer from a plurality of printer drivers stored at the print controller or a networked location accessible by the print controller.

21. The method according to claim 18, further comprising accessing the relevant printer driver for the selected printer from a plurality of printer drivers stored at the print controller or a networked location accessible by the print controller.

22. An apparatus adapted to select a network printer to receive a file to be printed on the instigation of a mobile device, the network having at least one communications point for providing access to devices on the network from the mobile device, the apparatus comprising:
a print controller connected to the network and having access to predetermined properties of a plurality of networked printers; the print controller being arranged to receive at least one user preference from the mobile device via the communications point; and
a matching arrangement adapted to match at least one of the predetermined properties of the printers with the at least one user preference, and to select the printer that is to print the file in accordance with results of the match.

23. A program storage device, readable by a machine, tangibly embodying a program of instructions executable by the machine to perform a method of selecting a printer on a network to receive a file to be printed on the instigation of a mobile device, the method comprising:
sending at least one user preference from the mobile device to a networked print controller, the print controller having access to predetermined properties of a plurality of networked printers,
matching at least one of the predetermined properties of the plurality of networked printers with the at least one user preference, and
selecting the printer that is to print the file in accordance with the results of matching at least one of the predetermined properties of the plurality of networked printers with the at least one user preference.

24. The program storage device of claim 23, wherein the user preference comprises a current location of the mobile device and the method further comprises:
determining a location of the mobile device relative to at least one wireless communication point of the network by measuring a transmitted wireless signal strength of the at least one wireless communication point at the current location of the mobile device
wherein sending at least one user preference from the mobile device to a networked print controller comprises transmitting the measured signal strength to the print controller via the network;
wherein matching at least one of the predetermined properties of the plurality of networked printers with the at least one user preference comprises comparing the measured wireless signal strength at the mobile device with a plurality of stored wireless signal strengths of the at least one communications point at each of the printer locations; and
wherein selecting the printer that is to print the file comprises selecting a printer to send the file to having the best match resulting from comparing the measured wireless signal strength at the mobile device with a plurality of stored wireless signal strengths of the at least one communications point at each of the printer locations.

25. A program storage device, readable by a machine, tangibly embodying a program of instructions executable by the machine to perform a method of printing a file to a networked printer at the instigation of a mobile device, the method comprising:
selecting a networked printer comprising:
sending at least one user preference from the mobile device to a networked print controller, the print controller having access to predetermined properties of a plurality of networked printers,
matching at least one of the predetermined properties of the plurality of networked printers with the at least one user preference, and
selecting the printer that is to print the file in accordance with the results of matching at least one of the predetermined properties of the plurality of networked printers with the at least one user preference; and
transmitting the file to the selected printer for printing.

26. The program storage device of claim 25, wherein the file is stored on the mobile device, is transmitted to the print controller via a wireless communication point and subsequently forwarded onto the selected printer for print out.

27. The program storage device of claim 25, wherein the file is stored on a networked file server, is selected by the mobile device and subsequently sent to the selected printer for print out by the print controller.

28. The program storage device of claim 25, further comprising accessing the relevant printer driver for the selected printer from a plurality of printer drivers stored at the print controller or a networked location accessible by the print controller.
